(19) United States
(12) Patent Application Publication
(10) Pub. No.: US 2005/0219606 A1
(43) Pub. Date: Oct. 6, 2005

(54) Image print ordering method and print order accepting server

(76) Inventors: Keisuke Tanaka, Tokyo (JP); Shinsuke Katoh, Tokyo (JP)

Correspondence Address: BIRCH STEWART KOLASCH & BIRCH, PO BOX 747, FALLS CHURCH, VA, 22040-0747, US

(21) Appl. No.: 10/941,855

(22) Filed: Sep. 16, 2004

(30) Foreign Application Priority Data
Sep. 17, 2003 (JP) 2003-325169

(51) Int. Cl. G06K 1/00

(52) U.S. Cl. 358/1.15

(57) ABSTRACT

A print order accepting server comprising: a receiving device which receives an image from a customer via a network, together with the information of a dispatch destination designated by the customer; a database registering the information of production base, including the positional information of a plurality of production bases for producing a photo print; a calculation device which calculates a delivery cost of the photo print produced at each of the plurality of production bases based on the positional information of the plurality of production bases and the received dispatch destination information; a production base deciding device which decides a production base having the cheapest delivery cost based on the delivery costs calculated by the calculation device; and a transmitting device which transmits the received image and the dispatch destination information via the network to the production base decided by the production base deciding device.

### BACKGROUND OF THE INVENTION

1. Field of the Invention

The present invention relates to an image print ordering method and a print order accepting server, and more particularly to an image print ordering method and a print order accepting server that are suitable for printing an image uploaded via a network from the customer in a form complying with a request of the customer.

2.Description of the Related Art

Conventionally, when a print order for an image is accepted from the customer at a shop counter, a production base for printing is generally uniquely decided. That is, it is common that the shop is the production base for printing, or the shop places an order of printing to the predetermined production base (laboratory). In this case, the customer receives the printed image at the shop counter.

By the way, along with the spread of a digital camera in recent years, and the development of a network technology, as the background, a method for sending the individual image data via the network to place an image print order has been widely employed. That is, the customer places an image print order at an in-home terminal (mainly a personal computer) without going to the shop, and receives the printed image finished at the production base (laboratory) by home delivery service.

Also, regarding such services, an image print ordering method, an image saving system, a terminal unit, an image saving program and an image saving method in which a number of images are saved for easy handling have been offered. (refer to Japanese Patent Application Publication No. 2003-115975).

### SUMMARY OF THE INVENTION

However, when such a service is employed, it is not often possible to comply with the request of the customer, if the production base for printing is uniquely decided as conventionally.

For example, when the dispatch destination of the print image designated by the customer is remote from the production base (laboratory), the cost and the time for delivery are taken in excess. Accordingly, it is required to select the optimal production base to comply with the request of the customer.

Also, the customer usually wants the service with the cheapest cost, but some customers take preference of the appointed time before the cost, such as on the season of the New Year's card.

By the way, in the conventional service, there was no fine print ordering method capable of dealing with the request of the customer individually.

This invention has been achieved in the light of the above-mentioned problems, and it is an object of the invention to provide an image print ordering method and a print order accepting server that can provide a fine service capable of complying with the request of the customer individually.

In order to accomplish the above object, the present invention provides a print order accepting server comprising: a receiving device which receives an image from a customer via a network, together with the information of a dispatch destination designated by the customer, a database registering the information of production base, including the positional information of a plurality of production bases for producing a photo print, a calculation device which calculates a delivery cost of the photo print produced at each of the plurality of production bases based on the positional information of the plurality of production bases and the received dispatch destination information, a production base deciding device which decides a production base having the cheapest delivery cost based on the delivery costs calculated by the calculation device, and a transmitting device which transmits the received image and the dispatch destination information via the network to the production base decided by the production base deciding device.

In this invention, it is preferable to further comprise a device for acquiring the production cost of the photo print produced at each of the plurality of production bases, wherein the production base deciding device decides the production base at which the total value of the delivery cost calculated by the calculation device and the acquired production cost is minimum.

Also, the invention provides an image print ordering method of deciding a production base for performing the print, printing an image at the production base, and dispatching the image after printing to a dispatch destination designated by the customer in accepting an image print order in a server connected to a network from the customer, the method comprising the steps of: prompting the customer to select a cost preference or a delivery time preference in accepting the print order; inputting the dispatch destination information designated by the customer into the server, and selecting the production bases near the dispatch destination from among a plurality of production bases registered in the server or a recording device connected to the server; calculating the production required cost and the delivery cost for each production base in performing the printing at each of the selected production bases, and allowing the server to decide the production base at which the total value of the production required cost and the delivery cost is minimum, when the selection of the customer is the cost preference; and calculating the production required time and the time for delivery for each production base in performing the printing at each of the selected production bases, and allowing the server to decide the production base at which the total value of the production required time and the time for delivery is minimum, when the selection of the customer is the delivery time preference.

According to the invention, in accepting the print order, the customer is prompted to select the cost preference or the delivery time preference, and the server decides the production base with the lowest cost, or the production base with the shortest time for delivery to comply with the request of the customer. Thereby, it is possible to provide the image print ordering method capable of providing the fine services to deal with the request of the customer individually.

In the invention, it is preferable that a loaded condition at the production base is employed as a numerical value in calculating the production required cost and/or the production required time. The loaded condition at the production base often varies daily. In this case, if the loaded condition at the production base is employed as the numerical value and the cost and/or time for delivery are calculated, the object of the invention is suitably achieved.

Also, in this invention, it is preferable that a postal code and/or address is employed as the dispatch information designated by the customer in the step of selecting the production bases near the dispatch destination. This is because the production bases near the dispatch destination are easily selected employing the postal code and/or address.

As described above, with the invention, in accepting the print order, the customer is prompted to select the cost preference or the delivery time preference, and the server decides the production base with the lowest cost, or the production base with the shortest time for delivery to comply with the request of the customer. Thereby, it is possible to provide the image print ordering method and the print order accepting server capable of providing the fine services to deal with the request of the customer individually.

### BRIEF DESCRIPTION OF THE DRAWINGS

FIG. 1 is a diagram showing an image print ordering system according to an embodiment of the present invention;

FIG. 2 is a block diagram showing the configuration of a communication terminal unit;

FIG. 3 is a block diagram showing the configuration of a center server;

FIG. 4 is an input screen of the communication terminal unit;

FIG. 5 is an input screen of the communication terminal unit;

FIG. 6 is a schematic view showing a table for use in selecting the production base;

FIG. 7 is a schematic view showing a table for use in selecting the production base;

FIG. 8 is a view showing the screens displayed on a portable telephone display possessed by the customer when using a print service system;

FIG. 9 is a view showing the screens displayed on a portable telephone display possessed by the customer when using the print service system;

FIG. 10 is a view showing the screens displayed on a portable telephone display possessed by the customer when using the print service system; and

FIG. 11 is a view showing the screens displayed on a portable telephone display possessed by the customer when using the print service system.

### DETAILED DESCRIPTION OF THE PREFERRED EMBODIMENTS

The preferred embodiments of an image print ordering method and a print order accepting service according to the present invention will be described below in detail with reference to the accompanying drawings.

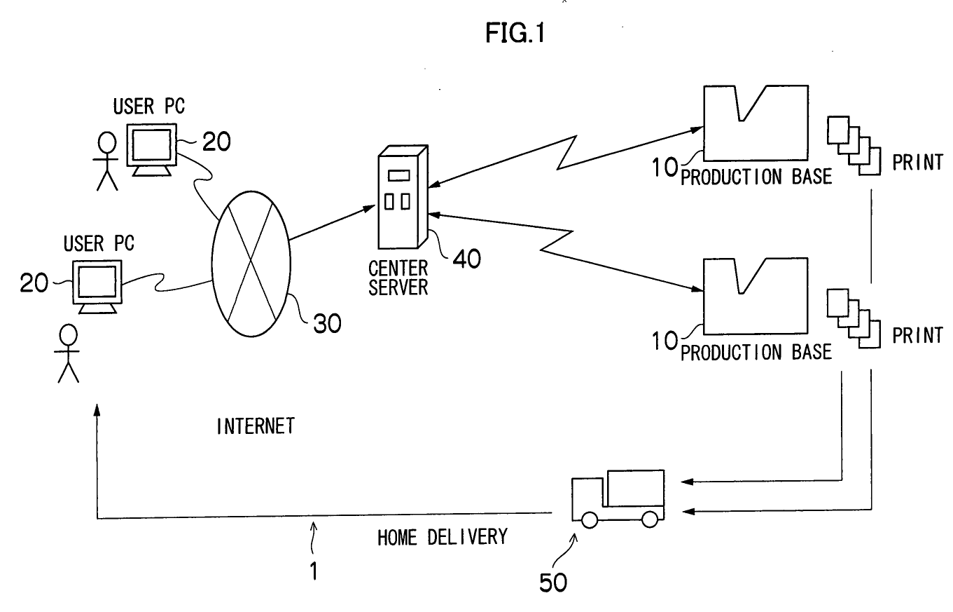

As shown in FIG. 1, an image print ordering system 1, to which an image print ordering method and a print order accepting server according to the embodiment of the invention are applied, comprises a plurality of production bases 10, a plurality of communication terminal units 20 used by the customer, the Internet 30, a server 40 (center server) having an electronic mail transmitting and receiving function, a mail box function, an electronic mail management function, and an image management function of saving and managing the image, and a home delivery system 50 for dispatch the image to the customer.

The communication terminal unit 20 is connected via the Internet 30 to the center server 40, and transmit or receive various kinds of information to or from the center server 40 as a transaction.

In this embodiment, a centralized system in which the center server 40 performs the centralized processing for the communication terminal units 20 is taken as an example, but the invention may be also applicable to a distributed system composed of a plurality of servers.

In this image print ordering system 1, it is required that the customer makes the customer registration by transmitting the customer information to the center server 40 to save the image in the center server 40. Herein, the transmission of customer information occurs preferably during or before the transmission of image, but may occur after the transmission of image.

The communication terminal unit 20 is composed of a so-called personal computer connectable to the Internet 30, for example. The communication terminal unit 20 is employed when the customer saves the image photographed by a digital camera in the center server 40, registers the information of customer (customer information) in the center server 40, or reads the image saved in the center server 40, for example. The communication terminal unit 20 may be a private terminal or a portable telephone connected via a private line to the center server 40.

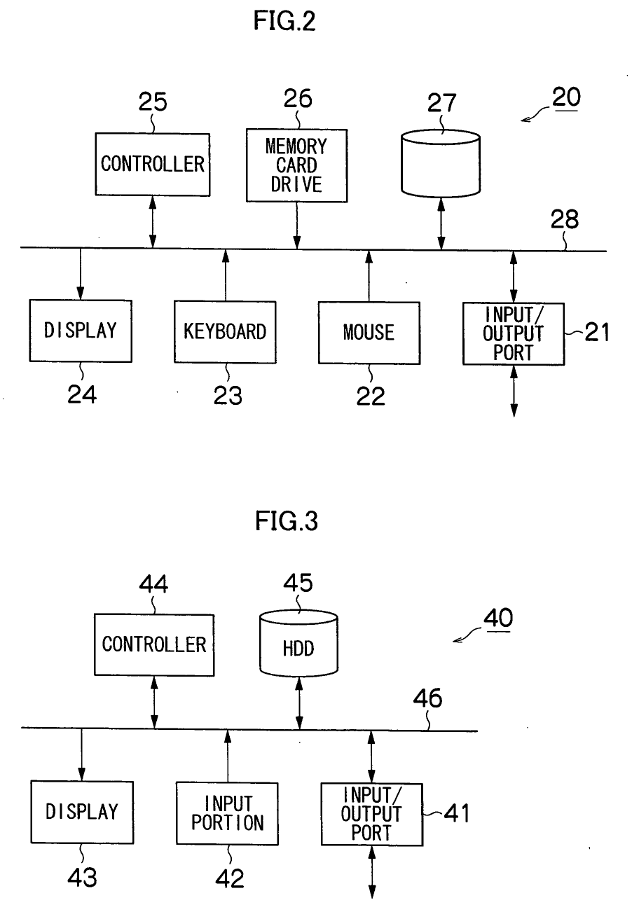

The communication terminal unit 20 specifically comprises an input/output port 21 for inputting or outputting data via the Internet 30, a mouse 22 that is a pointing device, a keyboard 23 for inputting the numerical value or character, a display 24 for displaying the input result, a controller 25 for controlling the overall operation, a memory card drive 26 for reading the image recorded in the memory card, a hard disk drive 27 for storing data, and a bus 28 for connecting each unit, as shown in FIG. 2.

The mouse 22 is employed when selecting the image displayed on the Web site, or specifying the input position of character. The keyboard 23 is employed when inputting the customer information, image attribute information, or image selection information. Instead of the mouse 22 and the keyboard 23, a dedicated input unit having a pointing device function and a function of inputting the numerical value or character may be employed.

The display 24 may be a liquid crystal display, a CRT display (Braun tube), an EL (Electroluminescence) display, a plasma display, or a television receiver, for example. Moreover, a so-called touch panel having the functions of the mouse 22, keyboard 23 and display 24 may be employed. The controller 25 transmits the customer information, image selection information and image attribute information input from the mouse 22 or keyboard 23, and the image data read from the memory card drive 26 via the input/output port 21 to the center server 40. The controller 25 can also display the image on the display 24, based on the data from the center server 40.

In the case where the communication terminal unit 20 is the portable telephone, it has a simpler constitution without having the mouse 22 and the hard disk drive 27.

The center server 40 once saves all the images transmitted from the communication terminal unit 20, arranges and classifies the images by associating them with the customer information and image attribute information, and saves the arranged and classified images. And the center server 40 put the saved image on the Web site, transmits predetermined data upon an instruction of the communication terminal unit 20, or places a print order for the saved image to predetermined production base 10.

The center server 40 specifically comprises an input/output port 41 for inputting or outputting data via the Internet 30, an input portion 42 composed of a mouse or a keyboard, a display 43 for displaying the input result, a controller 44 for controlling the overall operation, a hard disk drive 45 for storing various kinds of database and programs, and a bus 46 for interconnecting each unit, as shown in FIG. 3.

The controller 44 issues a customer ID (Identification) and a password if receiving the new customer information, associates the image stored in the hard disk drive 45 with various kinds of information, and classifies the images, for example. Also, the controller 44 has a clock function of measuring the current date and time.

The hard disk drive 45 can store a large amount of data to be able to once save all the images from the production base 10 or the communication terminal unit 20.

The production base 10 is represented by a laboratory shop such as a total laboratory shop (large laboratory shop) or a mini laboratory shop to print the image ordered by the customer.

Various kinds of information can be transmitted or received as a transaction between the center server 40 and each production base 10. In this case, the center server 40 and each production base 10 may be connected by a public line such as the Internet 30, or a private line.

The home delivery system 50 forwards the image printed at the production base 10 to the dispatch destination designated by the customer, and corresponds to various home delivery services or a parcel delivery of the post office.

The operation of the image print ordering system 1 will be described below. An electronic mail with the image attached is sent from the communication terminal unit 20 on the customer side via the Internet 30 to the center server 40. In the center server 40, a mail acceptance application is initiated to read the image data, the customer address (from address) and the text from the electronic mail.

Also, the center server 40 issues an ID/password for access. When this ID/password is assigned to the from address, the ID/password is newly issued.

Moreover, the center server 40 determines whether or the acceptance is made. This determination for acceptance is made by referring to the format of attached image and the upper limit and lower limit of the image size.

In the center server 40, after the above operation, a mail reply/deletion application is initiated. In this application, a reply mail is created and sent via the Internet 30 to the communication terminal unit 20 on the customer side.

The reply mail is created, describing 1) encrypted URL, 2) access ID/password, 3) entry URL, and 4) support inquiry mail destination.

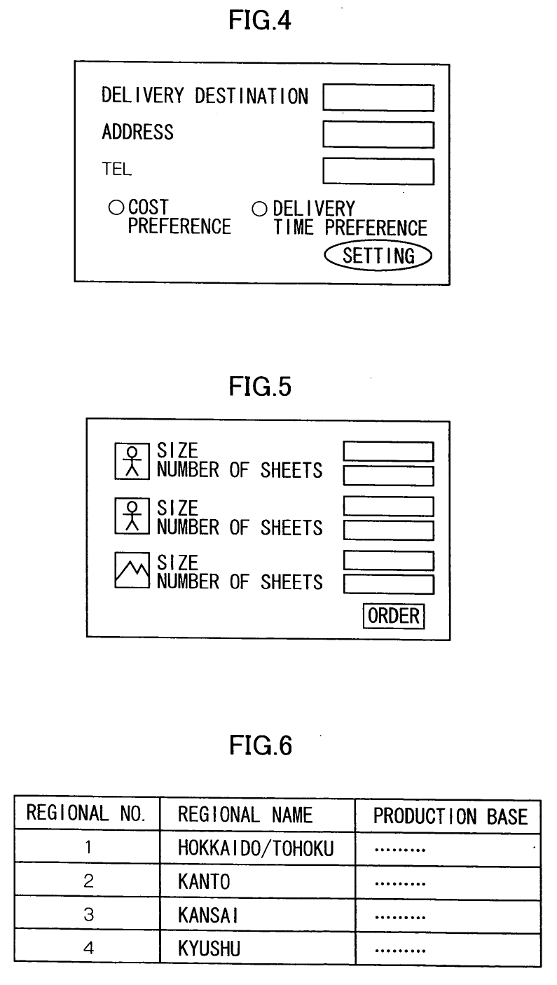

The customer receiving the reply mail inputs the contents of order into the communication terminal unit 20 on the customer side. FIGS. 4 and 5 show the input screens of the communication terminal unit 20. In a screen of FIG. 4, the dispatch destination (delivery destination) designated by the customer, address (including the postal code), and telephone number are input. Also, the buttons for allowing the user to select the cost preference or delivery time preference are provided on the screen of FIG. 4, prompting the customer to select either “cost preference” or “delivery time preference”. If the “setting” button is finally depressed on the screen of FIG. 4, the system is switched to the next screen as shown in FIG. 5.

On the screen of FIG. 5, the size of each image and the number of sheets ordered by the customer are input. There are three kinds of ordered images as show in FIG. 5. If there are more kinds of images, the screen is scrolled to input them. By operating an “order” button, the contents of order are decided, and transmitted to the center server 40.

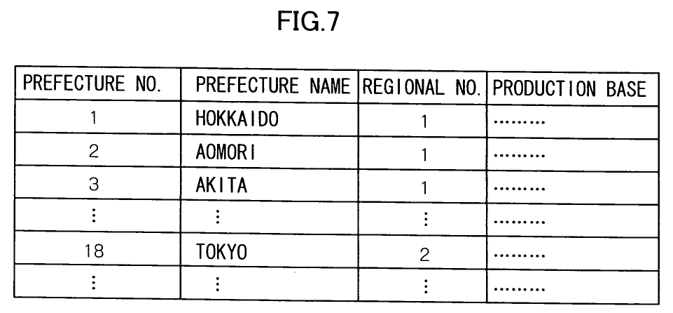

In the center server 40, production bases near the dispatch destination are selected from among a plurality of production bases registered in the server, based on the dispatch destination information designated by the customer. This method for selecting the production bases may take various forms, but preferably uses the postal code and/or address as the dispatch destination information designated by the customer. FIGS. 6 and 7 are schematic views showing the tables used with this method.

The methods using the address as the dispatch destination information designated by the customer include using the regional name (regional table) for partition as shown in FIG. 6 and using the prefecture name (prefecture table) for partition as shown in FIG. 7.

A regional table of FIG. 6 is partitioned into Hokkaido/Tohoku, Kanto, Kansai, and Kyushu, in which the regional number is assigned to each partition. A prefecture table of FIG. 7 is partitioned into To, DO, Fu and prefectures, such as Hokkaido, Aomori, Akita, . . . , in which the prefecture number is assigned to each partition.

In the regional table of FIG. 6, the regional number is extracted from the prefecture at the address, and the production base assigned to the regional number is selected. In the prefecture table of FIG. 7, the production base assigned to the prefecture number is selected from the prefecture at the address.

Another method using the postal code as the dispatch destination information designated by the customer may be employed. In this case, it is preferable to decide the number of digits of the postal code to be used, depending on the number of production bases nationwide or the density of production bases in a certain region. That is, the postal code used at present has 7 digits in total, and the region is defined from the first digit to the last digit. Accordingly, when the number of production bases nationwide is large, the postal code is defined using from the first to fifth digits, or when the number of production bases nationwide is small, the postal code is defined using from the first to third digits, for example.

A method for deciding the production base upon a selection of the customer in the center server 40 will be described below. In this case, a choice between cost preference (selecting the cheapest fee) and delivery time preference (selecting the earliest delivery time) is made by the customer.

In the method for deciding the production base, when the cost preference is made by selection of the customer, the production required cost and the delivery cost are calculated for each of the selected production bases for performing the printing, and the production base in which the total value of production required cost and delivery cost is minimum is decided.

On the other hand, when the delivery time preference is made by selection of the customer, the production required time and the delivery time are calculated for each of the selected production bases for performing the printing, and the production base in which the total value of production required time and the delivery time is minimum is decided.

In the above way, the factors for deciding the cost may be the production required cost and the delivery cost, but the production cost required for the customer is needed to be uniform in all parts of the country on the nature of the print ordering service (e.g., 35 yen per sheet in the print of L-size). On the other hand, the delivery cost is different depend on the delivery region and the delivery time. To attain its idea, it is always a correct choice to select the production base nearest to the dispatch destination designated by the customer.

However, when the production base is selected in this way, many orders are concentrated on the production base, possibly resulting in nonconformity that the time limit required for production is extremely longer. Accordingly, when the cost preference is made, it is preferable to set a predetermined time limit (e.g., within seven days) as a prerequisite condition.

A factor for deciding the time limit of delivery will be described below. One factor for deciding the production required time may be a loaded condition of the production base. The loaded condition of the production base is decided by the productive capacity of the production base and the amount of orders received at the production base. That is, the productive capacity at the production base is not uniform, and the amount of orders received at each production base may often vary with the season.

It is beneficial that the loaded condition of this production base is employed as a numerical value to make calculations in deciding the production base. For example, the loaded condition of each production base is simply represented as a numerical value, using a load factor of calculating the value with the amount of orders received at each production base as numerator and the productive capacity of each production base as denominator.

In this case, if the load factor is below 1.0, the productive capacity has a margin, whereby the normal value of the time limit of delivery is employed as the production required time and added to the time limit for delivery. On the other hand, if the load factor is beyond 1.0, the productive capacity has no margin, and a delay in the delivery time according to the load factor is expected. In this case, the production required time according to the load factor is calculated, and added to the time limit for delivery. The time limit for delivery may be the home delivery time limit of the home delivery agency.

Also, even if the load factor at the predetermined production base (e.g., production base nearest to the dispatch destination designated by the customer) is beyond 1.0, the load may be distributed over a plurality of production bases.

For example, when the load factor at the production base nearest to the dispatch destination designated by the customer is beyond 1.0, the amount of orders received is shared at the production base till the load factor at the production base is equal to 0.8, and the remaining amount of orders received is shared at the other production base that is selected to be next nearest to the dispatch destination designated by the customer. If the load factor at the production base is beyond 1.0, the amount of orders received is shared at the production base till the load factor at the production base is equal to 0.8, and the remaining amount of orders received is further shared at the other production base, and so forth.

As described above, according to the invention, the server decides the production base with the lowest cost, or the production base with the shortest period for delivery to comply with the customer's wishes. Thereby, it is possible to provide the image print ordering method and the print order accepting server in which fine services are allowed to comply with the customer's wishes individually.

### EXAMPLES

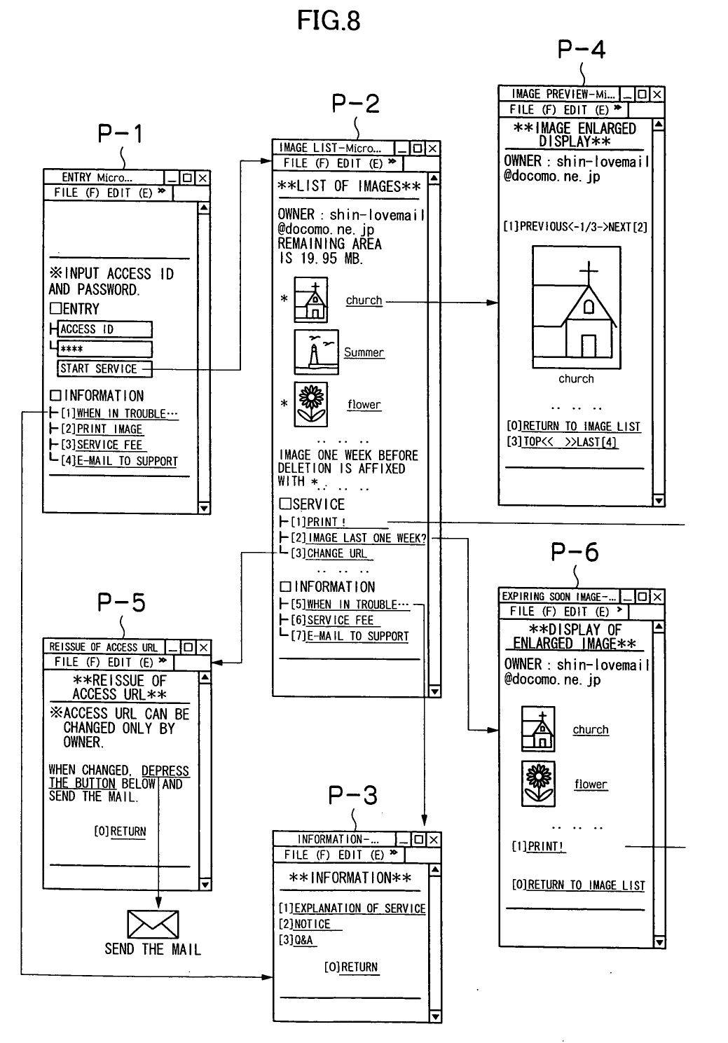

An image print service system of the portable telephone to which the image print ordering method and the print order accepting server according to the invention is applied will be described below. FIGS. 8 to 11 are views showing the screens displayed on the display of the portable telephone possessed by the customer when employing this print service system.

In FIG. 8, if the access ID and password are input on screen (Picture) P-1, the system transfers to screen P-2. When the customer is at a loss in the input operation on the screen P-1 or screen P-2, the system transfers to screen P-3 by operating the relevant switch (screen P-3 and beyond are omitted).

A list of images that the customer has already transmitted to the center server 40 is displayed on the screen P-2. Particularly, the images one week before deletion are appended with * mark. In this way, the image having passed a predetermined term is deleted, because there is a limit on the storage capacity of the service system.

When the customer wants to confirm the details of an image in the list of images, the system transfers to screen P-4 to display the image in enlargement by clicking the title character (“church” in the figure) of the image (screen P-4 and beyond are omitted).

When the URL is changed on the screen P-2, the system transfers to screen P-5 by operating the relevant switch (screen P-5 and beyond are omitted).

Also, when the customer wants to display only the images one week before deletion on the screen P-2, the system transfers to screen P-6 by operating the relevant switch.

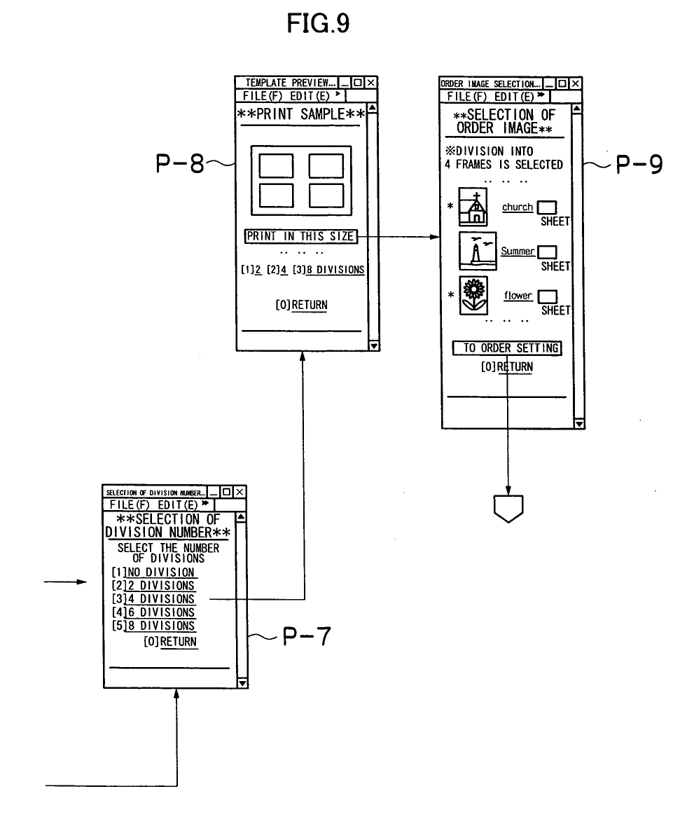

When the customer makes a print request for the selected image on the screen P-2 or screen P-6, the system transfers to screen P-7 of FIG. 9 by operating the relevant switch.

The customer is prompted to select the number of divisions in print on the screen P-7. Generally, since the image photographed by the portable telephone has less number of pixels, the image quality is often degraded, when the image is printed in the normal print size (L size). Also, when a plurality of images are printed in one sheet of printing paper, the cost per image is less expensive. Under these circumstances, there is a great demand that the customer selects the number of divisions in printing. In this example, four divisions are selected on the screen P-7.

If the number of divisions is selected on the screen P-7, the system transfers to screen P-8 to display a preview image with the selected number of divisions. The customer confirms the contents of the preview image, and the system transfers to screen P-9 by operating the relevant switch if there is no problem.

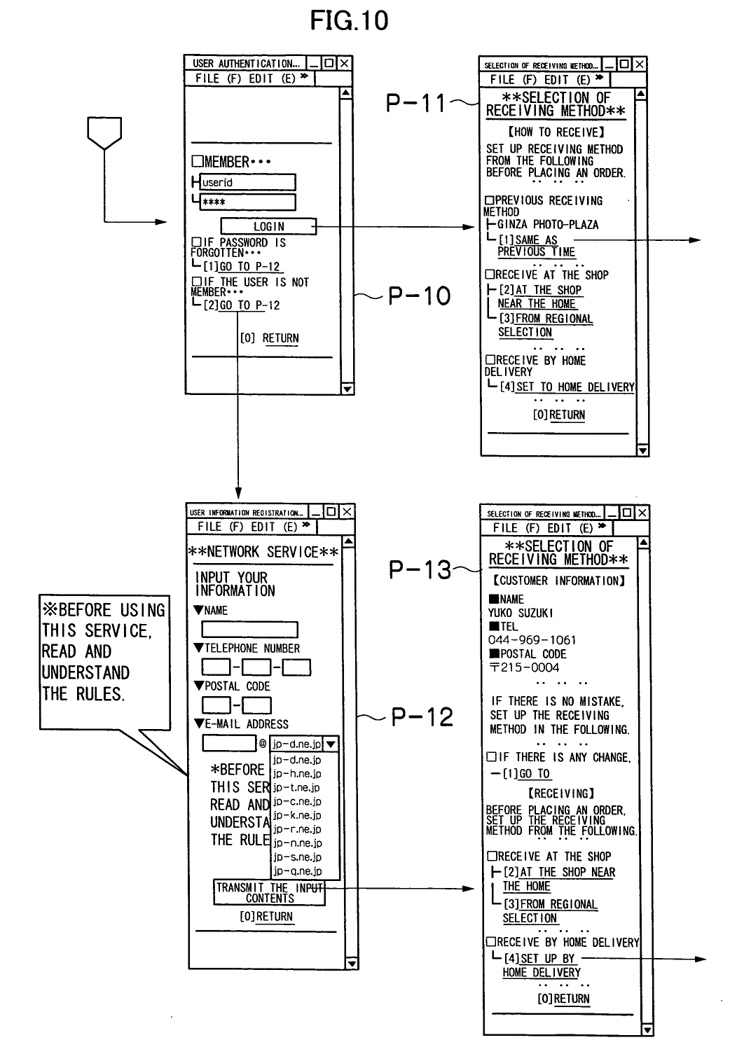

The customer is prompted to select an order image and input the print number of order images on screen P-9. After input of the print number, the system transfers to screen P-10 of FIG. 10 by operating the relevant switch (order setting).

If the member of this system inputs the user ID and the password on the screen P-10, the system is logged in, and transfers to screen P-11 for selecting the receiving method. On the other hand, when the customer is the member of this system but forgets the password, or not the member of this system on the screen P-10, the system transfers to the next screen by operating the relevant switch. In this example, the system transfers to screen P-12 by operating the switch when the password is forgotten.

The information of the customer is input on the screen P-12 for network service. The name, telephone number, postal code and E-mail address are inputted on this screen. After input, the system transfers to the next screen P-13 by operating the input contents sending switch.

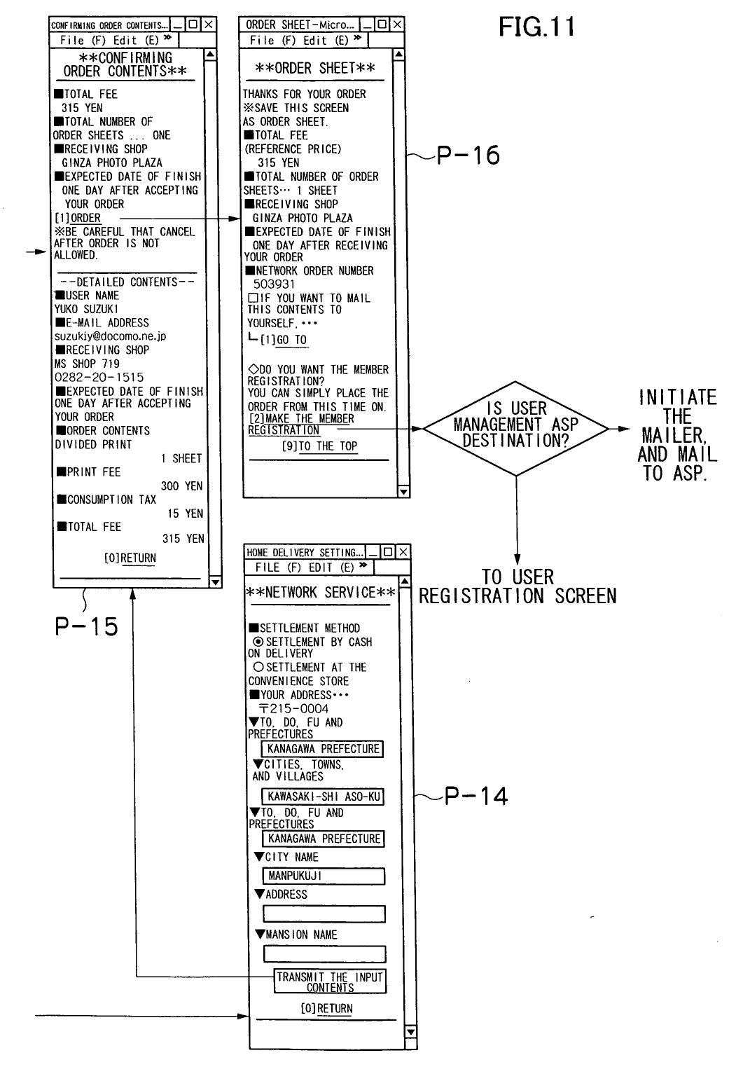

If the information of the customer is correct on the screen P-13, the print receiving method is selected. On this screen, the customer can select the “receive at the shop near the home”, “receive at the shop in selected region”, or “receive by home delivery”. In this example, the switch of “receive by home delivery” is operated, and the system transfers to screen P-14 of FIG. 11.

The customer is prompted to select the settling method on the screen P-14. On this screen, the customer can select the “settlement with cash on delivery” or “settlement at the convenience store. In this example, the “settlement with cash on delivery” is selected.

Also, the customer is prompted to select “cost preference” or “delivery time preference” on screen P-14. In this example, “delivery time preference” is selected. And if the information of the customer is correctly displayed, the input contents sending switch is depressed, and the system transfers to the next screen P-15. In this process, the image print ordering method and the print order accepting server are applied, and the production base is decided by the hardware and software as already described. And the time limit of delivery and the cost are calculated under the conditions.

On the screen P-15 for confirmation of order contents, the total fee, total order number, accepting shop, and tentative deadline for finish are displayed. Also, the detailed contents including the user name, E-mail address, accepting shop, tentative deadline for finish, order content, print fee, consumption tax, and total fee are displayed. If the detailed contents have no mistake, the “order” switch is operated, and the system transfers to the next screen.

On the other hand, returning to the screen P-10, when the member of this system has logged in, the system transfers to the next screen P-11. The screen P-11 is the screen for selecting the receiving method, in which the customer can select the “same as previous time”, “receive at the shop near home”, “receive at the shop selected in region”, or “receive by home delivery”. In this example, the switch “same as previous time” is operated, and the system transfers to the screen P-15 of FIG. 11. The screen P-15 has been already explained.

The order sheet is displayed on the screen P-16, and the customer is prompted to save this screen. The customer is prompted to select the “mail the order contents to oneself”, “member registration”, or “return to the top page” in the next operation.

Herein, when the “member registration” is selected, the procedure is different depending on whether the user management is made by ASP (Application Service Provider). When the user management is made by ASP destination, the mailer is initiated to mail to the ASP, or otherwise the system transfers to a user registration screen.

1. A print order accepting server comprising:
a receiving device which receives an image from a customer via a network, together with the information of a dispatch destination designated by the customer;
a database registering the information of production base, including the positional information of a plurality of production bases for producing a photo print;
a calculation device which calculates a delivery cost of the photo print produced at each of the plurality of production bases based on the positional information of the plurality of production bases and the received dispatch destination information;
a production base deciding device which decides a production base having the cheapest delivery cost based on the delivery costs calculated by the calculation device; and
a transmitting device which transmits the received image and the dispatch destination information via the network to the production base decided by the production base deciding device.

2. The print order accepting server according to claim 1, further comprising a device which acquires the production cost of the photo print produced at each of the plurality of production bases, wherein the production base deciding device decides the production base at which the total value of the delivery cost calculated by the calculation device and the acquired production cost is minimum.

3. An image print ordering method of deciding a production base for performing the print, printing an image at the production base, and dispatching the image after printing to a dispatch destination designated by the customer in accepting an image print order to a server connected to a network from the customer, the method comprising the steps of:
prompting the customer to select a cost preference or a delivery time preference in accepting the print order;
inputting the dispatch destination information designated by the customer into the server, and selecting the production bases near the dispatch destination from among a plurality of production bases registered in the server or a recording device connected to the server;
calculating the production required cost and the delivery cost for each production base in performing the printing at each of the selected production bases, and allowing the server to decide the production base at which the total value of the production required cost and the delivery cost is minimum, when the selection of the customer is the cost preference; and
calculating the production required time and the time for delivery for each production base in performing the printing at each of the selected production bases, and allowing the server to decide the production base at which the total value of the production required time and the time for delivery is minimum, when the selection of the customer is the delivery time preference.

4. The image print ordering method according to claim 3, wherein a loaded condition at the production base is employed as a numerical value in calculating at least one of the production required cost and the production required time.

5. The image print ordering method according to claim 3, wherein at least one of a postal code and address is employed as the dispatch information designated by the customer in the step of selecting the production bases near the dispatch destination.

6. The image print ordering method according to claim 4, wherein at least one of a postal code and address is employed as the dispatch information designated by the customer in the step of selecting the production bases near the dispatch destination.
